(19) United States
(12) Patent Application Publication
(10) Pub. No.: US 2004/0045980 A1
(43) Pub. Date: Mar. 11, 2004

(54) Personal hydration system with pump

(76) Inventor: Duncan G. Robins, McKinleyville, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 10/653,011

(22) Filed: Aug. 28, 2003

Related U.S. Application Data
(60) Provisional application No. 60/409,278, filed on Sep. 6, 2002.

(51) Int. Cl. B67D 5/08; B67D 5/14

(52) U.S. Cl. 222/63

(57) ABSTRACT

A hands-free, personal hydration system utilizes a peristaltic pump to deliver fluid from a reservoir through a drinking tube to a user's mouth. The pump can be activated by the user's lips completing a circuit upon touching the mouthpiece for a drink.

### CROSS-REFERENCE TO RELATED APPLICATIONS

This application claims the benefit of U.S. Provisional Application No. 60/409,278 filed Sep. 6, 2002.

### FIELD OF THE INVENTION

The present invention relates to personal hydration systems and, in particular, to personal hydration systems that deliver fluids from a reservoir to a user through a drinking tube.

### BACKGROUND OF THE INVENTION

Personal hydration systems provide a convenient way of supplying fluids. Since many of these systems are used to provide hydration during exercise, there has been much interest in hydration systems that minimize the amount of effort and disruption required to obtain fluids and to provide sufficient amounts of fluids. Among the hydration systems having improved fluid delivery capabilities are those systems that include a powered pump and those that do not include a pump (“pump-less” systems).

Pump-less systems operate under the action of a user drawing fluid from the reservoir, with or without the assistance of gravity. These systems have recently been improved by incorporating larger tubes, simpler spouts for filling, and leak-proof reservoirs. A prior art pump-less hydration system 100 for holding and delivering a fluid 113 is illustrated in FIG. 1. System 100 includes a reservoir 110 with a filling spout 111 and an exit port 112. Exit port 112 is connected to a drinking tube 120, which in turn is connected to a mouthpiece 130. The user fills reservoir 110 with a desired amount of fluid 113, and closes filling spout 111 to seal the reservoir. From the user's perspective, the operation of system 100 is similar to drinking through a straw. The user inhales sucks on mouthpiece 130 to draw fluid 113 from reservoir 110 into the user's mouth. The rate at which fluid is supplied to the user depends on the amount of suction and the fluid resistance through the system. While this is a simple process, it can be taxing, especially if the user is already exerting significant energy and having to breathe hard while exercising. In addition, the use of pump-less systems requires one to hold their breath for a significant period of time for each drink.

Recent improvements have been made to hydration systems. As described in U.S. Pat. Nos. 5,571,260 and 5,645,404, pumps can provide fluid to a user's mouth while eliminating the need to suck. While these systems require less time to obtain a drink, they require the use of the user's hands, and are thus of limited use while exercising.

FIGS. 2A and 2B depict another prior art hydration system 200 with a pump 240 fluidly connected to a drinking tube 220 and near the top of a reservoir 210. A switch 242 located near the mouthpiece 230 can be activated by a hand manipulating the tube. Batteries 241 are situated near the pump 240. System 100 includes a carrying device 270.

These pump systems, however, have several limitations. First, these aforementioned systems require the pump to come in contact with the liquid. As a result, the pump has to be cleaned after every use to keep it sanitary.

The prior pump-enhanced systems also require a hand to switch the pump on. This is may be a problem for user during physical exertion, or when the user's hands are otherwise occupied.

What is needed is an improved hydration system. Such a system should be easy to clean and maintain, should provide sufficient quantities of fluid to the user on demand, and should preferably be able to supply fluids without the use of the hands.

### SUMMARY OF THE INVENTION

The present invention solves the above-identified problems of hydration systems by providing a system having a peristaltic pump actuated by the contact of the user's lips on the fluid supply tube.

The current invention includes a fluid reservoir, a drinking tube and a pump for propelling the fluid from the reservoir to a user's mouth. In one embodiment, the pump is activated when the lips of the user complete an electronic circuit. In another embodiment, the pump is activated when the lips cause a contact switch to close, completing a circuit for powering the pump.

The present invention provides an external, peristaltic device that clamps on to the tube, and propels the liquid by squeezing. The pump does not come in contact with the fluid, eliminating the need to clean the pump. The pump may be driven by an electric, mechanical, or electro-mechanical motor that is, preferably, activated electronically.

One aspect of the present invention provides a personal hydration system to facilitate the delivery of fluid from a reservoir, through a tube, to an open end of said tube. The system includes a pump having a mouth-actuated switch and attached to said tube to provide, when said switch is mouth-activated, a flow of fluid to said user. In one embodiment, the mouth-actuated switch includes a sensor responsive to an action of said user's mouth at said open end, and an electrical circuit operably connected to said sensor to provide power to said pump.

Another aspect of the present invention provides a personal hydration system to facilitate the delivery of fluid from a reservoir, through a tube, to an open end of said tube, where the system comprises a bendable support attached to said tube.

It is one advantage of the present invention to provide hands-free drinking without having to hold one's breath while sucking.

It is another advantage of the present invention to provide a pump that does not contact the drinking fluid.

It is another advantage of the present invention to provide a pump that can be retrofitted onto prior art “pump-less” systems.

A further understanding of the invention can be had from the detailed discussion of the specific embodiment below. For purposes of clarity, this discussion refers to devices, methods, and concepts in terms of specific examples. However, the advantages of the present invention may be realized using a variety of pumps, reservoirs, and delivery tubes. It is therefore intended that the invention not be limited by the discussion of specific embodiments.

### BRIEF DESCRIPTION OF THE DRAWINGS

Additional advantages of the invention will become apparent upon reading the following detailed description and upon reference to the drawings, in which:

FIG. 1 is a perspective view of a prior art pump-less hydration system;

FIGS. 2A and 2B is a perspective view of a prior art pump enhanced system;

FIG. 3 is a perspective view of one embodiment of the present invention showing a hands-free, peristaltic pump system;

FIG. 4 is a side view of the embodiment of FIG. 3 as the mouthpiece is placed in the users'mouth;

FIG. 5 is a top view of the embodiment of FIG. 3; and

FIG. 6 is a circuit diagram of the embodiment of FIG. 3.

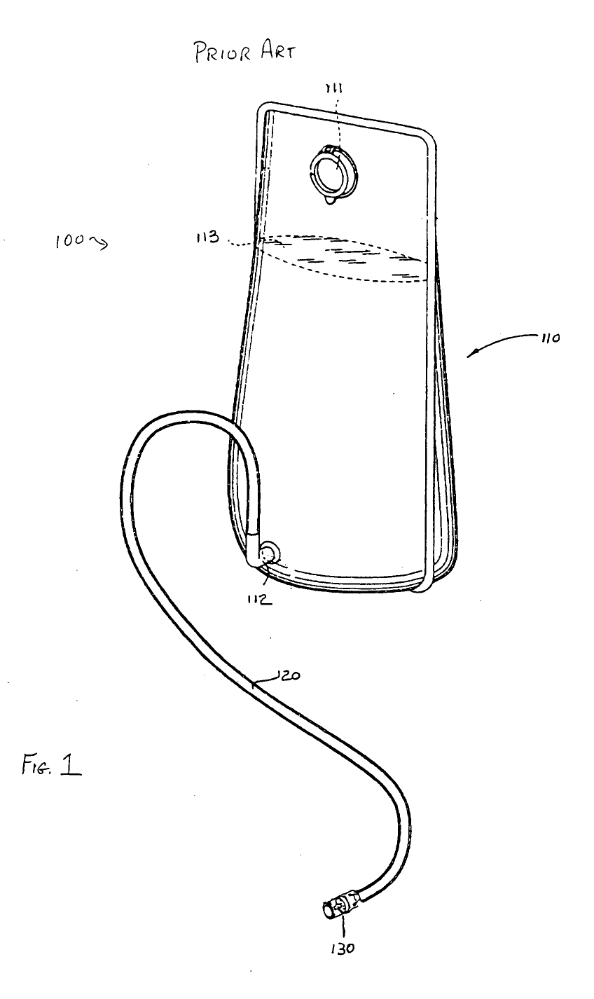

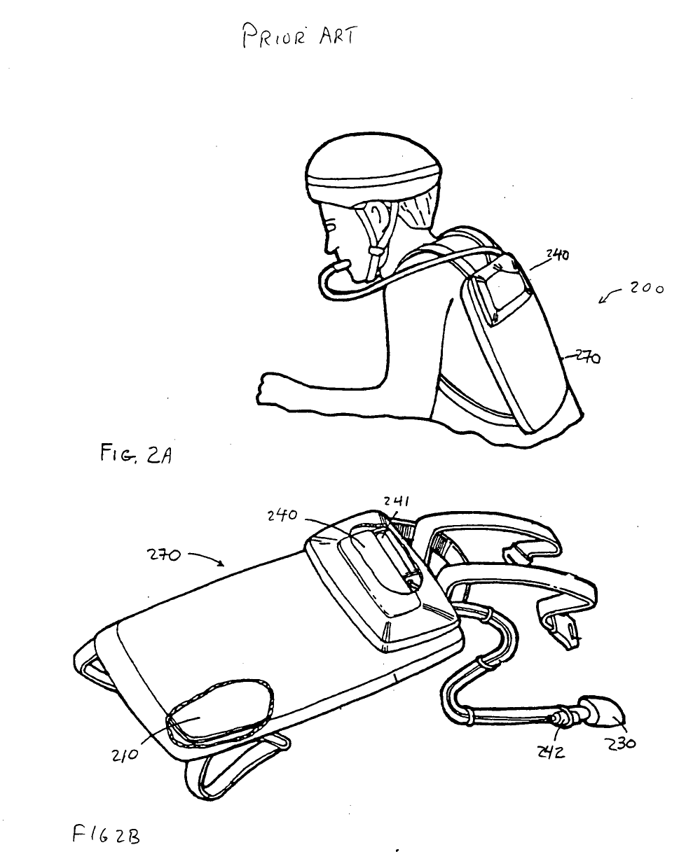

### DETAILED DESCRIPTION OF THE INVENTION

Exemplary embodiments are described herein with reference to specific configurations. Those skilled in the art will appreciate that various changes and modifications can be made to the exemplary embodiments while remaining within the scope of the invention. The present invention will now be described in more detail with reference to the Figures.

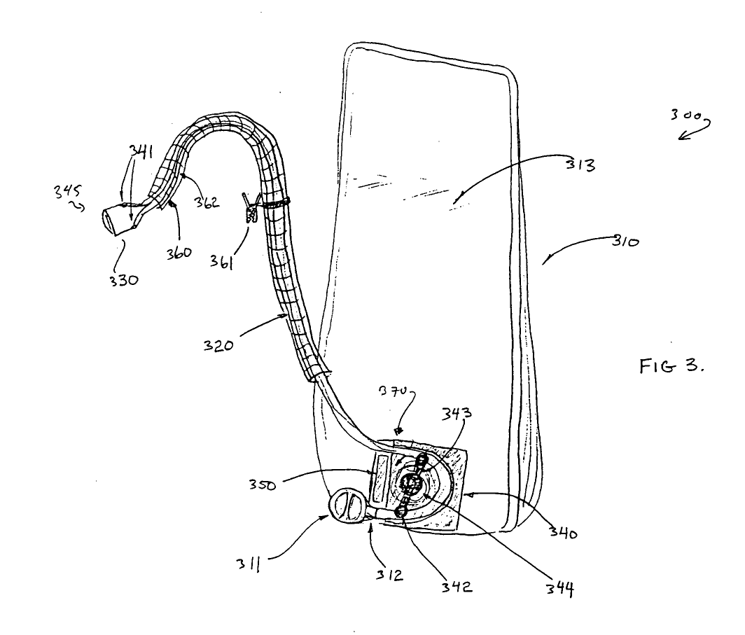

An embodiment of the present invention is described in relation to FIGS. 3-6. FIG. 3 is an illustration of a personal hydration system 300 that includes a pump 340 that can be activated without needing to use a hand to manipulate a switch. The system includes a reservoir 310 having a fill spout 311, and a drinking tube 320 connected to the reservoir through an exit port 312 located near the reservoir base. The other, open end of tube 320 includes a mouthpiece 330 for dispensing fluid. System 300 also includes a device for delivering fluid to the user, including a pump 340 attached to tube 320, a mouth-actuated sensor 345 on mouthpiece 330, wires 343 having ends 341 on the mouthpiece and leading from the sensor to a circuit 370, and batteries 350.

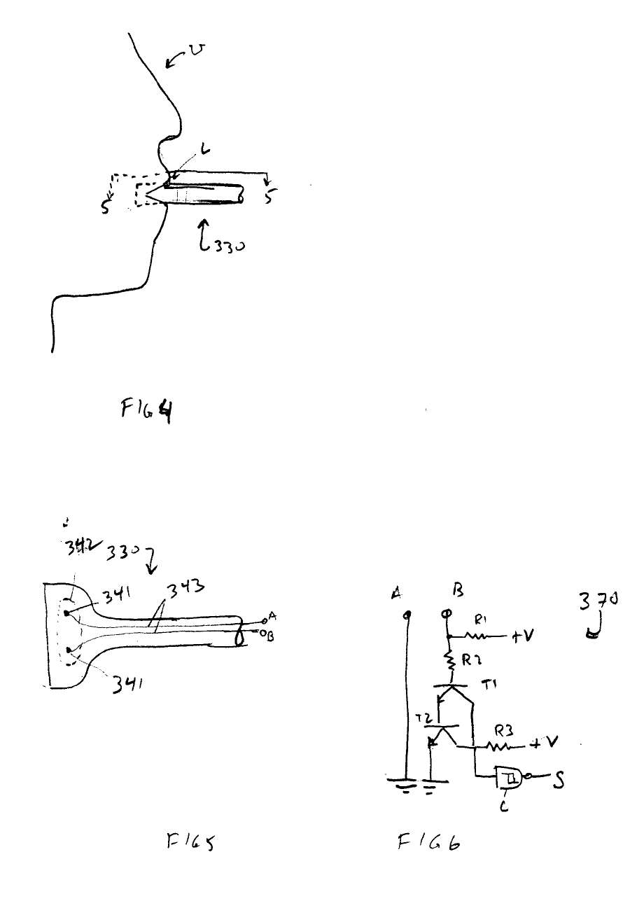

Details of one embodiment of mouthpiece 330 are shown in the side view of FIG. 4 and the top view of FIG. 5. In the embodiment of FIGS. 4-5, mouthpiece 330 is flared at the end that dispenses fluid, providing a preferred orientation for placing in the mouth of a user M. The mouthpiece is an open tube, or alternatively is a bite valve. The elongated cross section of mouthpiece 330 has a preferred location for placing the lips when a drink is desired, as shown by the dotted line 342 of FIG. 5.

Drinking tube 320 is connected to the reservoir 310 near the pump 340 at the exit port of the reservoir, to allowing the pump to be primed by gravity when the reservoir is holding liquid. Pump 340 is controlled by circuit 370, which is connected to mouthpiece 330 through wires 343, and powered by batteries 350. More specifically, circuit 370 is actuated by the action of the user's lips on a mouth-actuated sensor 345.

Sensor 345 includes wire ends 314 that located on mouthpiece 330 that are connected to circuit 370 by wires 343 along tube 320. Circuit 370 is responsive to a mouth-actuated action, preferably the touching of the user's lips, on sensor 345, which provides switches power to pump 340 when actuated. The actuated pump 340 draws fluid out of reservoir 310 and forces the liquid through tube 320 to mouthpiece 330 for consumption by the user.

The inventive personal hydration system shown in FIG. 3 uses a touch sensitive sensor 345 on mouthpiece 330 and a circuit 370 to actuate the pump. In one embodiment, sensor 345 is actuated by as a result of the resistance change across the ends of wires 341 on mouthpiece 330. Specifically, the user's touching of the ends of wires 341 results in resistance change between the wires that is sensed by a circuit which then that powers pump 340 with batteries 350. For example, the user contacts the end of wires 341 with the user's lips to actuate the pump.

One such actuating circuit 370 is illustrated in U.S. Pat. No. 3,944,843 to Vaz Martins (the “Vaz Martins patent”), incorporated herein by reference. In the Van Martins patent, a circuit is provided that senses the resistance between the wire ends. The circuit is bistable, and responds to the resistance across the wire ends. When the resistance drops from high value when the ends are not contacted by the user to a lower value corresponding to the resistance across the contact surface, the state of the circuit changes. This change of state can be further sensed by a conventional circuit that causes power from batteries to be coupled to the pump.

Sensor 345 and circuit 370 are illustrated in FIGS. 5 and 6. Wire ends 342 of FIG. 5 are shown leading to circuit 370 as wires A and B. Wires A and B are connected to circuit 370 are shown in FIG. 6. Circuit 370 is the circuit described in the Vaz Martins patent, including a voltage +V, delivered by batteries 350, resistors R1, R2, and R3, as shown in FIG. 3 of the Vaz Martin patent, transistors T1 and T2, (element 10 and 11 in FIG. 3 of the Vaz Martin patent), and a bistable circuit C (element 12 in FIG. 3 of the Vaz Martin patent). Circuit 370 produces a switching signal S, that is connected to pump 340, and that is responsive to resistance changes at wire ends 342. In particular, a decrease in the resistance at wire ends 342, due for example to lips L touching the ends, provides a signal S that further provides power to pump 340 using circuits known in the art.

An alternative circuits 370 for actuating the pump are within the scope of this patent. One such circuit is described in U.S. Pat. No. 3,879,618 to Larson, and incorporated herein by reference, which is a more sophisticated version of the circuit of the Vaz Martins patent. The circuit of the Larson patent requires three wires, and improves the operation and reliability of the circuit of the Vaz Martins patent by eliminating leakage current across the wire ends. Circuits for actuating the inventive pump would be obvious to one skilled in the art after consideration of the disclosure of the present patent application. In addition, it would likewise be obvious to use other actuating means, such as switches or multiple actuators on the mouthpiece.

FIG. 3 also depicts one example of a support mechanism 360. Support mechanism 360 includes an additional, thicker wire 361 that travels along the drinking tube. This wire is malleable enough to be bent easily, but resilient enough to hold its shape while holding the drinking tube 320 in the desired location. This support mechanism would likely also include a way to anchor the wire and drinking tube to the body of the user. A clip 361 is illustrated to represent an example of such an anchor. Wires 341, support wire 361, and drinking tube 320 can be located inside a cloth sleeve.

In FIG. 3, the pump is shown to be a rotary-style peristaltic pump 340. This style pump clamps on to the drinking tube 320 and squeezes the tube in order to draw and push the liquid from the reservoir to the mouthpiece of the user. Pump 340 includes rollers 342 attached to the end of spinning cams 343 that squeeze the tube. Pump 340 is powered by a mechanical device such as a coiled spring 344, or is alternatively powered by an electric motor, or a combination of a mechanical device and an electric motor. Since most of the energy is used by the pump, mechanical powering provides the advantage of avoiding the need for large batteries or frequent battery charging. Other types of peristaltic pumps could also be used. Alternatively, other types of pumps are known in the art that can be used in place of the peristaltic pump.

Having disclosed exemplary embodiments, modifications and variations may be made to the disclosed embodiments while remaining within the scope of the invention as described by the following claims.

What is claimed is:

1. A personal hydration system to facilitate the delivery of fluid from a reservoir, through a tube, to an open end of said tube comprising:
a pump having a mouth-actuated switch and connected to said tube to provide, when said switch is mouth-activated, a flow of fluid to said user.

2. The personal hydration system of claim 1, wherein said mouth-actuated switch includes:
a sensor responsive to an action of said user's mouth at said open end, and
an electrical circuit operably connected to said sensor to provide power to said pump.

3. The personal hydration system of claim 2, wherein said sensor includes the ends of conducting wires, wherein said electrical circuit is responsive to changes in the resistance between said conducting wire ends, and wherein said action is the touching of conducting wire ends by the lips of said user.

4. The personal hydration system of claim 2, wherein said switch includes a mechanical switch on said open end, wherein said electrical circuit is responsive to said mechanical switch, and wherein the action of the mouth of said user is the touching of the user's lips against said mechanical switch.

5. The personal hydration system of claim 1, wherein said pump is a mechanical motor, an electro-mechanical motor, or electronic motor.

6. The personal hydration system of claim 1, further including a bendable support for said tube.

7. The personal hydration system of claim 1, wherein said pump is mechanically powered.

8. A personal hydration system to facilitate the delivery of fluid to a user from a reservoir, through a tube to an open end of said tube, said system comprising:
a pump mechanically connected to said tube to provide a flow from said reservoir to said open tube end; and
a switch including a sensor responsive to an action of said user's mouth at said open end and an electrical circuit operably connected to said sensor to provide power to said pump.

9. The personal hydration system of claim 8, wherein said sensor includes the ends of conducting wires, wherein said electrical circuit is responsive to changes in the resistance between said conducting wire ends, and wherein said action is the touching of conducting wire ends by the lips of said user.

10. The personal hydration system of claim 8, wherein said switch includes a mechanical switch on said open end, wherein said electrical circuit is responsive to said mechanical switch, and wherein the action of the mouth of said user is the touching of the user's lips against said mechanical switch.

11. The personal hydration system of claim 8, wherein said pump is powered by a mechanical motor, an electro-mechanical motor, or electric motor.

12. The personal hydration system of claim 8, further including a bendable support for said tube.

13. The personal hydration system of claim 8, wherein said pump is mechanically powered.

14. A personal hydration system to facilitate the delivery of fluid from a reservoir, through a tube, to an open end of said tube comprising a bendable support attached to said tube.
